(19) United States
(12) Patent Application Publication
(10) Pub. No.: US 2025/0110482 A1
(43) Pub. Date: Apr. 3, 2025

(54) Automated Recipe Generation

(71) Applicant: FISHER-ROSEMOUNT SYSTEMS, INC, Round Rock, TX (US)

(72) Inventors: Gary K. Law, Killeen, TX (US); Cristopher Ian Sarmiento Uy, Metro Manila (PH); Andrew E. Cutchin, Killeen, TX (US)

(21) Appl. No.: 18/375,727

(22) Filed: Oct. 2, 2023

(51) Int. Cl. G05B 19/418; G10L 15/08

(52) U.S. Cl. CPC G05B 19/41835; G05B 19/4183; G10L 15/08; G10L 2015/088

(57) ABSTRACT

Techniques for automatically generating a process definition for an industrial process to create a product in an industrial plant are provided, including capturing sensor data associated with an individual performing a set of process operations to a set of process materials to make a product, analyzing the sensor data associated with the individual performing the set of process operations to the set of process materials to make the product, and identifying, based on analyzing the sensor data associated with the individual performing the set of process operations to the set of process materials to make the product, a process definition including the set of process materials, the equipment used to make the product, the set of process operations applied to the materials to make the product, a sequence of the process operations, a timing of the process operations, and/or a quantity of materials used in the process.

### TECHNICAL FIELD

This patent application relates generally to processes in industrial plants, and more specifically, to automatically generating a process definition for an industrial process to create a product in an industrial plant.

### BACKGROUND

Industrial or manufacturing processes, like those used in chemical, petroleum, pharmaceutical, paper, or other industrial process plants to produce physical products from source materials, typically include one or more process controllers communicatively coupled to one or more field devices via analog, digital or combined analog/digital buses, or via a wireless communication link or network. The field devices, which may be, for example, valves, valve positioners, switches and transmitters (e.g., temperature, pressure, level and flow rate sensors), are located within the process environment and generally perform physical or process control functions such as opening or closing valves, measuring process parameters, etc., to control one or more processes executing within the process plant or system. Smart field devices, such as the field devices conforming to the well-known FOUNDATION® Fieldbus protocol may also perform control calculations, alarming functions, and other control functions commonly implemented within the controller. The process controllers, which may be centrally located but which may also be located within the plant environment in a distributed manner, receive signals indicative of process measurements made by the field devices and/or other information pertaining to the field devices and execute a controller application that runs, for example, different control modules that make process control decisions, generate control signals based on the received information and coordinate with the control modules or blocks being performed in the field devices, such as HART®, WirelessHART®, and FOUNDATION® Fieldbus field devices. The control modules in the controller send the control signals over the communication lines or links to the field devices to thereby control the operation of at least a portion of the process plant or system.

Information from the field devices and the controller is usually made available from the controllers over a data highway to one or more other hardware devices, such as operator workstations, personal computers or computing devices, data historians, report generators, centralized databases, or other centralized administrative computing devices that are typically placed in control rooms or other locations away from the harsher plant environment. Each of these hardware devices typically is centralized across the process plant or across a portion of the process plant. These hardware devices execute applications that may, for example, enable an engineer to configure portions of the process or an operator to perform functions with respect to controlling a process and/or operating the process plant, such as changing settings of the process control routine, modifying the operation of the control modules within the controllers or the field devices, viewing the current state of the process, viewing alarms generated by field devices and controllers, simulating the operation of the process for the purpose of training personnel or testing the process control software, keeping and updating a configuration database, etc. The data highway utilized by the hardware devices, controllers and field devices may include a wired communication path, a wireless communication path, or a combination of wired and wireless communication paths.

As an example, the DeltaVIM control system, sold by Emerson Inc., includes multiple applications stored within and executed by different devices located at diverse places within a process plant. A configuration application, which resides in one or more workstations or computing devices, enables users to create or change process control modules and to download these process control modules via a data highway to dedicated distributed controllers. Typically, these control modules are made up of communicatively interconnected function blocks, which are objects in an object-oriented programming protocol that perform functions within the control scheme based on inputs thereto and that provide outputs to other function blocks within the control scheme. The configuration application may also allow a configuration designer to create or change operator interfaces that are used by a viewing application to display data to an operator and to enable the operator to change settings, such as set points, within the process control routines. Each dedicated controller and, in some cases, one or more field devices, stores and executes a respective controller application that runs the control modules assigned and downloaded thereto to implement actual process control functionality. The viewing applications, which may be executed on one or more operator workstations (or on one or more remote computing devices in communicative connection with the operator workstations and the data highway), receive data from the controller application via the data highway and display this data to process control system designers, operators, or users using the user interfaces, and may provide any of a number of different views, such as an operator's view, an engineer's view, a technician's view, etc. A data historian application is typically stored in and executed by a data historian device that collects and stores some or all of the data provided across the data highway while a configuration database application may run in a still further computer attached to the data highway to store the current process control routine configuration and data associated therewith. Alternatively, the configuration database may be located in the same workstation as the configuration application.

When an industrial or manufacturing process is being developed, the steps of the process have historically been recorded manually, where personnel who initially develop the process provide key process, materials, equipment, and procedural knowledge and information to personnel who implement the process, e.g., via paper lab notebooks, pdf files, spreadsheets, and the like. Thus, the accuracy and completeness of process knowledge information is easily compromised, which can not only increase the overall time to complete the process, but also can introduce risk into the product produced by the process. Unfortunately, such risks can lead to life-safety issues for both plant personnel and users of the end product, and in some cases can cause injury or death, for example, when risks are introduced into processes utilized to produce pharmaceutical, chemical, and other potentially hazardous and/or lethal products. To exacerbate these issues, manual tech transfer makes it difficult for product manufacturers to record and accurately report data necessary to find causes and contributing factors to product safety and quality and to comply with jurisdictional regulatory requirements. Still further, this manual tech transfer increases the testing and deployment time of a process.

Several digital tools have attempted to address these issues, however, these attempts suffer from shortcomings and drawbacks. For example, Product (vs. process) Lifecycle Management tools (“PLMs”) address the lifecycle stages of a physical end product and are not easily adaptable and/or optimized for aspects that are particular to the lifecycle stages of industrial and manufacturing processes which produce the physical end product. Further, PLMs are not easily customized, extended into, and/or integrated with site-specific execution systems, if at all.

Recently, some Process Knowledge Administration systems or tools (“PKAs”) have attempted to allow engineers and/or other process personnel to define processes, a priori, in a manner similar to those utilized in object-oriented techniques (e.g., object, class, module, instance, etc.). Such PKA tools provide a user interface and a database to enable users to define and store a set of related process definitions, from broad expressions down to specific implementation values, e.g., experimental process definitions, generic process definitions, site process definitions, control process definitions, and site-specific parameter values which may be passed from the tool to a particular site for implementation at the particular site. However, these tools still require manual process object and parameter definition a priori at the tool for the various object levels (e.g., object, class, module, instance, etc.), which can be cumbersome and time consuming for users.

Moreover, manually documenting and defining the steps of the process in this way can result in many of the same issues as manually documenting and defining the steps of the process in a lab notebook. In particular, manual documentation of a process often does not, or cannot, occur in real-time as a scientist or engineer performs the process, and is often done long after the actual process is complete. Consequently, manually documenting and defining steps of the process, whether using a lab notebook or PKA tools, can result in steps, measurements, etc. of the process being omitted or otherwise being mischaracterized, because the documentation occurs after a given step is complete, or after the entire process is complete. This can affect the accuracy of the process as recorded. When any of the elements of the process such as the amount of time that a given step takes (e.g., how quickly or slowly one material is poured into another material), an amount of time between steps, an order of the steps, a specific measurement of a material, a particular type of material, a particular method of mixing or combining materials, the specific characteristics and quantity of results, etc., as recorded by a scientist or engineer after the fact are incorrect, and especially when multiple of these elements are incorrect, the process can become more difficult to accurately replicate in future batches. An inaccurately replicated process can result in an incorrect result, or, in some cases, an unsafe or hazardous result.

### SUMMARY

In one aspect, a computer-implemented method for automatically generating a process definition for an industrial process to create a product in an industrial plant is provided. The method may include capturing sensor data associated with an individual performing a set of process operations to a set of process materials to make a product; analyzing the sensor data associated with the individual performing the set of process operations to the set of process materials to make the product; and identifying, based on analyzing the sensor data associated with the individual performing the set of process operations to the set of process materials to make the product, a process definition including one or more of: the set of process materials for making the product, one or more equipment used to make the product, the set of process operations applied to the materials to make the product, a sequence of the process operations, a timing of the process operations, or quantity information regarding the materials used in the process. The method may include additional, less, or alternate actions, including those discussed elsewhere herein.

In another aspect, a computer system for automatically generating a process definition for an industrial process to create a product in an industrial plant is provided. The computer system may include one or more sensors configured to capture sensor data associated with an individual performing a set of process operations to a set of process materials to make a product, one or more processors and a memory storing computer-executable instructions that, when executed by the one or more processors, cause the one or more processors to: analyze the sensor data associated with the individual performing the set of process operations to the set of process materials to make the product; and identify, based on analyzing the sensor data associated with the individual performing the set of process operations to the set of process materials to make the product, a process definition including one or more of: the set of process materials for making the product, one or more equipment used to make the product, the set of process operations applied to the materials to make the product, a sequence of the process operations, a timing of the process operations, or quantity information regarding the materials used in the process. The system may include additional, less, or alternate functionality, including that discussed elsewhere herein.

In still another aspect, a non-transitory computer-readable storage medium storing computer-readable instructions for automatically generating a process definition for an industrial process to create a product in an industrial plant is provided. The computer-readable instructions, when executed by one or more processors, cause the one or more processors to: analyze the sensor data associated with the individual performing the set of process operations to the set of process materials to make the product; and identify, based on analyzing the sensor data associated with the individual performing the set of process operations to the set of process materials to make the product, a process definition including one or more of: the set of process materials for making the product, one or more equipment used to make the product, the set of process operations applied to the materials to make the product, a sequence of the process operations, a timing of the process operations, or quantity information regarding the materials used in the process. The instructions may direct additional, less, or alternative functionality, including that discussed elsewhere herein.

In one aspect, a computer-implemented method for automatically generating a configuration hierarchy for a process definition for an industrial process to create a product in an industrial plant is provided. The method may include analyzing sensor data associated with an individual performing a set of process operations to a set of process materials to make a product; identifying, based on analyzing the sensor data associated with the individual performing the set of process operations to the set of process materials to make the product, the set of process operations applied to the materials to make the product and one or more equipment used in each of the process operations; and determining, based on the set of process operations applied to the materials to make the product and the one or more equipment used in each of the process operations, a hierarchy level of the industrial plant associated with each of the process operations. The method may include additional, less, or alternate actions, including those discussed elsewhere herein.

In another aspect, a computer system for automatically generating a configuration hierarchy for a process definition for an industrial process to create a product in an industrial plant is provided. The computer system may include one or more processors and a memory storing computer-executable instructions that, when executed by the one or more processors, cause the one or more processors to: analyze sensor data associated with an individual performing a set of process operations to a set of process materials to make a product; identify, based on analyzing the sensor data associated with the individual performing the set of process operations to the set of process materials to make the product, the set of process operations applied to the materials to make the product and one or more equipment used in each of the process operations; and determine, based on the set of process operations applied to the materials to make the product and the one or more equipment used in each of the process operations, a hierarchy level of the industrial plant associated with each of the process operations. The system may include additional, less, or alternate functionality, including that discussed elsewhere herein.

In still another aspect, a non-transitory computer-readable storage medium storing computer-readable instructions for automatically generating a configuration hierarchy for a process definition for an industrial process to create a product in an industrial plant is provided. The computer-readable instructions, when executed by one or more processors, cause the one or more processors to: analyze sensor data associated with an individual performing a set of process operations to a set of process materials to make a product; and identify, based on analyzing the sensor data associated with the individual performing the set of process operations to the set of process materials to make the product, the set of process operations applied to the materials to make the product and one or more equipment used in each of the process operations; and determine, based on the set of process operations applied to the materials to make the product and the one or more equipment used in each of the process operations, a hierarchy level of the industrial plant associated with each of the process operations. The instructions may direct additional, less, or alternative functionality, including that discussed elsewhere herein.

In one aspect, a computer-implemented method for visualizing a process definition for an industrial process to create a product in an industrial plant is provided. The method may include analyzing sensor data associated with an individual performing a set of process operations to a set of process materials to make a product; generating, based on captured sensor data associated with an individual performing a set of process operations to a set of process materials to make a product, a visualization of the set of process operations being performed to the set of process materials to make the product, wherein the visualization illustrates one or more of the set of process materials for making the product, one or more equipment used to make the product, the set of process operations applied to the materials to make the product, a sequence of the process operations, a timing of the process operations, or quantity information regarding the materials used in the process; and providing, via a user interface, the visualization of the individual performing the set of process operations to the set of process materials to make the product. The method may include additional, less, or alternate actions, including those discussed elsewhere herein.

In another aspect, a computer system for visualizing a process definition for an industrial process to create a product in an industrial plant is provided. The computer system may include one or more processors and a memory storing computer-executable instructions that, when executed by the one or more processors, cause the one or more processors to generate, based on captured sensor data associated with an individual performing a set of process operations to a set of process materials to make a product, a visualization of the set of process operations being performed to the set of process materials to make the product, wherein the visualization illustrates one or more of the set of process materials for making the product, one or more equipment used to make the product, the set of process operations applied to the materials to make the product, a sequence of the process operations, a timing of the process operations, or quantity information regarding the materials used in the process; and provide, via the user interface, the visualization of the individual performing the set of process operations to the set of process materials to make the product. The system may include additional, less, or alternate functionality, including that discussed elsewhere herein.

In still another aspect, a non-transitory computer-readable storage medium storing computer-readable instructions for visualizing a process definition for an industrial process to create a product in an industrial plant is provided. The computer-readable instructions, when executed by one or more processors, cause the one or more processors to: generate, based on captured sensor data associated with an individual performing a set of process operations to a set of process materials to make a product, a visualization of the set of process operations being performed to the set of process materials to make the product, wherein the visualization illustrates one or more of the set of process materials for making the product, one or more equipment used to make the product, the set of process operations applied to the materials to make the product, a sequence of the process operations, a timing of the process operations, or quantity information regarding the materials used in the process; and provide, via the user interface, the visualization of the individual performing the set of process operations to the set of process materials to make the product. The instructions may direct additional, less, or alternative functionality, including that discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary computer system for automatically generating a process definition for an industrial process to create a product in an industrial plant, automatically generating a configuration hierarchy for a process definition for an industrial process to create a product in an industrial plant, and/or visualizing a process definition for an industrial process to create a product in an industrial plant, according to one embodiment;

FIG. 2 depicts an exemplary individual performing a set of process operations to a set of process materials to make a product, and exemplary sensors configured to capture sensor data associated with the individual performing the set of process operations to the set of process materials to make the product, according to one embodiment;

FIG. 3 depicts an exemplary plant hierarchy in an industrial plant, according to one embodiment;

FIG. 4 depicts a flow diagram of an exemplary computer-implemented method for automatically generating a process definition for an industrial process to create a product in an industrial plant, according to one embodiment;

FIG. 5 depicts a flow diagram of an exemplary computer-implemented method for automatically generating a configuration hierarchy for a process definition for an industrial process to create a product in an industrial plant, according to one embodiment; and

FIG. 6 depicts a flow diagram of an exemplary computer-implemented method for visualizing a process definition for an industrial process to create a product in an industrial plant, according to one embodiment.

While the systems and methods disclosed herein is susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

The novel systems, methods, and techniques provided herein allow for and enable a process “recipe” to be generated accurately in real-time as the process is performed by an individual (e.g., a scientist, engineer, operator, worker, etc.). In an embodiment, sensor data may be captured in real-time as the individual performs the process. This sensor data may include images and/or videos captured of the individual, equipment, materials, etc., as the individual performs the steps of the process, as well as audio data captured as the individual performs the steps of the process. For instance, in some examples, the audio data may include data associated with words or phrases spoken by the individual as the individual performs the steps of the process. In some examples, the sensor data may include data from sensors associated with equipment involved in the steps of the process. For instance, the sensor data may include data from motion or weight sensors indicative of times and/or amounts of times at which equipment are used, or weights/dimensions of materials used with the equipment. Moreover, in some examples, the sensor data may include location data associated with equipment or materials as they are used and moved while the individual completes the steps of the process.

A machine learning model may be trained to associate sensor data with particular process steps. The sensor data may be analyzed (e.g., using the machine learning model) to identify a process definition for the “recipe” including the set of process materials for making the product, one or more equipment used to make the product, the set of process operations applied to the materials to make the product, a sequence of the process operations, a timing of the process operations, quantity information regarding the materials used in the process, etc. Moreover, the sensor data may be analyzed to identify hierarchical levels of the plant associated with each step/element of the process, or with the process as a whole. Advantageously, the accuracy of the process as recorded is greatly improved because data associated with the steps of the process is captured in real-time, as an individual performs the process, and does not rely on estimations and/or approximations of process steps after the steps of the process are performed.

The process definition, as determined based on the sensor data, may be provided to a user via a user interface. In some examples, the process definition may be provided via the user interface as a written or otherwise graphically depicted series of steps, measurements, times, etc. A user may interact with the process definition as provided via the user interface to make adjustments, clarifications, or corrections to the process as determined based on the sensor data, as well as notes associated with various steps of the process.

Moreover, in some examples, a visual depiction of the process may be provided via the user interface. For instance, in some examples, an augmented reality (AR) depiction of the process as performed by the individual may provided as an overlay over the actual plant where the individual performed the process, or over an image or video of the plant where the individual performed the process. For instance, this may allow a new user looking to replicate the steps of the process to follow the steps and timing process as performed by the individual and shown in the AR overlay. Furthermore, in some examples, when multiple processes (or the same process) performed by multiple users are captured, an AR depiction of the process as performed by each individual may both be overlaid over actual plant where the individuals performed the process, or over an image or video of the plant where the individuals performed the process, so that multiple individuals' performances of the process can be compared/contrasted. For instance, in some examples, multiple individuals' performances of the process can be compared for training purposes. As another example, multiple individuals' performances of the process, and the respective results of each performance of the process, can be compared to identify how any differences between the performance of the process may affect the ultimate results of the process.

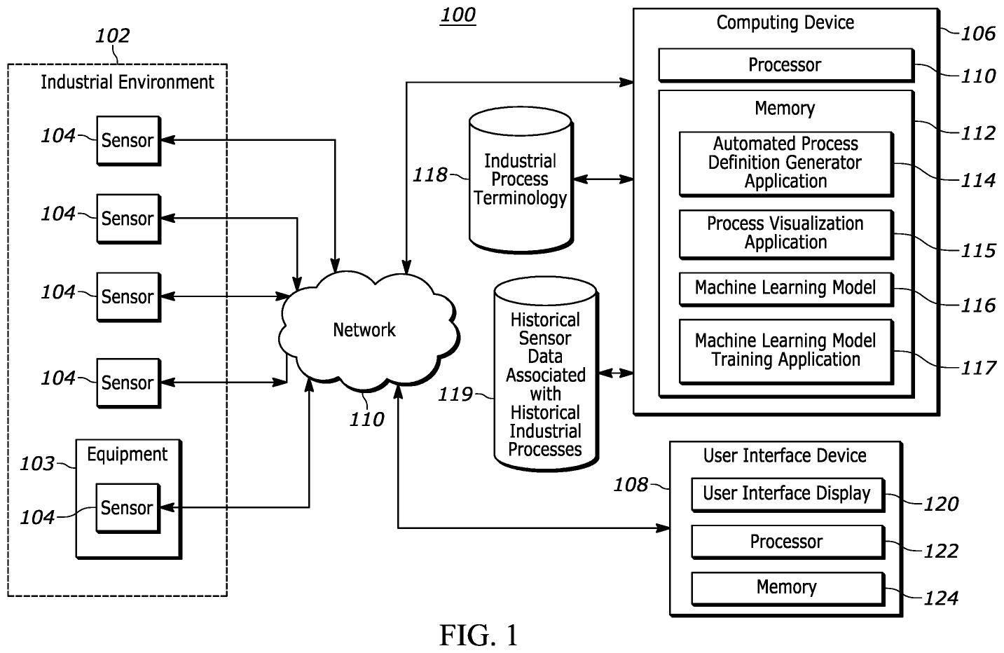

Referring now to the drawings, FIG. 1 depicts an exemplary computer system 100 for automatically generating a process definition for an industrial process to create a product in an industrial plant, automatically generating a configuration hierarchy for a process definition for an industrial process to create a product in an industrial plant, and/or visualizing a process definition for an industrial process to create a product in an industrial plant, according to one embodiment according to one embodiment. The high-level architecture illustrated in FIG. 1 may include both hardware and software applications, as well as various data communications channels for communicating data between the various hardware and software components, as is described below.

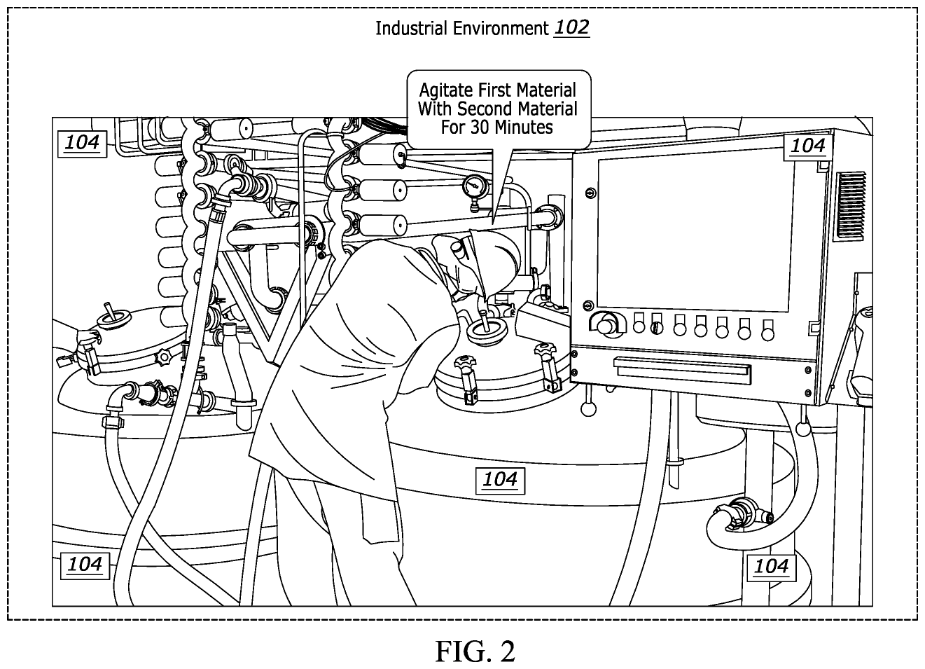

The system 100 may be implemented within or in connection with an industrial environment 102 (e.g., an industrial plant) including industrial equipment 103 (which may include field devices of an industrial plant), and may include one or more sensors 104 positioned within the industrial environment 102. In some examples, one or more of the sensors 104 may be attached to or integrated within pieces of the industrial equipment 103 of the industrial environment 102. Generally speaking, the sensors 104 may be configured to capture data associated with an individual (e.g., an operator, scientist, engineer, or other individual in the industrial environment 102) performing a set of process operations to a set of process materials to produce a product. For instance, FIG. 2 depicts an exemplary individual performing a set of process operations to a set of process materials to make a product in the industrial environment 102, and exemplary sensors 104 configured to capture sensor data associated with the individual performing the set of process operations to the set of process materials to make the product.

The sensors 104 may be configured to capture various types of data associated with the individual performing the set of process operations to the set of process materials to make the product. The sensor data may include image data, video data, and/or audio data associated with the individual as the individual performs the process operations to the set of process materials to make the product using the equipment 103. Moreover, the sensors 104 may be configured to capture data associated with the equipment 103 and/or materials involved in the set of process operations. Furthermore, the sensors 104 may be configured to capture location data associated with the individual, the materials, the equipment 103, etc., as the individual performs the process operations to the set of process materials to make the product using the equipment 103.

The system 100 may further include a computing device 106, as well as, in some cases, one or more user interface devices 108 (which may include, e.g., smart phones, smart watches or fitness tracker devices, tablets, laptops, virtual reality headsets, smart or augmented reality glasses, wearables, etc., that include a user interface). The sensors 104, the computing device 106, and the user interface devices 108 may be configured to communicate with one another via a wired or wireless computer network 110. To facilitate such communications the equipment 103, sensors 104, computing device 106, and/or user interfaces 108 may each respectively comprise a wireless transceiver to receive and transmit wireless communications.

Although one piece of equipment 103, five sensors 104, one computing device 106, one user interface 108, and one network 110 are shown in FIG. 1, any number of such equipment 103, sensors 104, computing devices 106, user interfaces 108, and/or networks 110 may be included in various embodiments. Moreover, although only the equipment 103 and sensors 104 are shown within the industrial environment 102 in FIG. 1, in some examples, the computing device 106, user interface device 108, and/or network 110 may also be within the industrial environment 102. Furthermore, although the computing device 106 and the user interface device 108 are shown as separate devices in FIG. 1, in some examples, these devices may be integrated as a single device, e.g., a stationary or mobile computing device 106 having a user interface component. Similarly, although the sensors 104 are shown as separate from the computing device 106 and/or the user interface device 108, in some examples, the sensors 104 may be attached to or integrated with the computing device 106 and/or the user interface device 108.

In some embodiments the computing device 106 may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) 110 (e.g., CPUs) as well as one or more computer memories 112.

Memories 112 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 122 may store an operating system (OS) (e.g., Microsoft Windows, Linux, UNIX, etc.) capable of facilitating the functionalities, apps, methods, or other software as discussed herein. Memorie(s) 112 may also store an automated process definition generator application 114, a process visualization application 115, a machine learning model 116, and/or a machine learning model training application 117.

Additionally, or alternatively, the memorie(s) 112 may store data from various sources, including industrial process terminology data, as well as historical sensor data associated with historical industrial processes. The industrial process terminology data may also be stored in an industrial process terminology database 118, which may be accessible or otherwise communicatively coupled to the computing device 106. Furthermore, the historical sensor data associated with historical industrial processes may be stored in a historical sensor data associated with historical industrial processes database 119. In some embodiments, the industrial process terminology data, the historical sensor data associated with historical industrial processes, and/or other data from various sources may be stored on one or more blockchains or distributed ledgers.

Executing the automated process definition generator application 114 may include causing the sensors 104 to capture sensor data associated with an individual as the individual performs a process in the industrial environment 102 using the equipment 103. For instance, the automated process definition generator application 114 may analyze the sensor data captured by the sensors 104 to identify a process definition for the process. The process definition may include, for instance, the set of process materials for making the product, the equipment 103 used to make the product, the set of process operations applied to the materials to make the product, a sequence of the process operations, a timing of the process operations, quantity information regarding the materials used in the process, etc.

For instance, in some examples, the automated process definition generator application 114 may analyze images or videos of the individual performing the process, as captured by the sensors 104, to identify various aspects of the process. For instance, the proximity of the individual to a particular piece of equipment 103, as shown in an image or video of the process, may indicate that the individual is performing a step associated with that piece of equipment 103. Furthermore, the motions of the individual, as shown in an image or video of the process, may indicate what type of step the individual is performing, such as a step of moving a material between locations, a step of heating a material, a step of mixing or agitating multiple materials together, etc. Additionally, the automated process definition generator application 114 may analyze images or videos of the individual performing the process to identify particular materials involved in the process, e.g., based on shapes, sizes, colors, or other visual characteristics associated with the materials or their containers, or based on barcodes, symbols, and/or optical character recognition of words or serial numbers printed on the materials themselves or their containers. Similarly, the automated process definition generator application 114 may analyze images or videos of the individual performing the process to identify particular equipment 103 in the industrial environment 102 involved in the process, e.g., based on shapes, sizes, colors, or other visual characteristics associated with the equipment 103, or based on barcodes, symbols, and/or optical character recognition of words or serial numbers printed on the equipment 103 in the industrial environment 102, or based on the location of the equipment 103 in the industrial environment 102.

Moreover, in some examples, the automated process definition generator application 114 may analyze audio data associated with the individual performing the process, as captured by the sensors 104, to identify various aspects of the process. For instance, the audio data may be analyzed to identify materials, equipment 103, and/or steps of the process based on sounds associated with particular materials and/or equipment 103, and/or based on sounds associated with particular process steps. For example, a particular piece of equipment 103 may make a particular sound during a mixing step, and the automated process definition generator application 114 may analyze audio data associated with the individual performing the process, as captured by the sensors 104, to identify the equipment 103 and/or to identify that the mixing step is being performed by the equipment 103.

Additionally, the audio data may be analyzed to identify words or phrases spoken by the individual as the individual performs the process. For instance, the individual may verbally narrate the steps of the process as the individual performs the process (e.g., “Agitate first material with second material for 30 minutes,” as shown in FIG. 2, “Heat one pound of material using equipment name for 20 minutes,” etc.). The individual's verbal narration of the process may be analyzed, e.g., using natural language processing and/or a version of natural language processing informed by the industrial process terminology database 118, to identify steps of the process, the order of the steps of the process, the amount of time associated with each step of the process, the equipment used during each step of the process, the materials used during each step of the process and their respective amounts, etc.

Furthermore, in some examples, the automated process definition generator application 114 may analyze data captured by sensors 104 that are associated with or integrated with the equipment 103 as the individual performs the process. For instance, a piece of equipment 103 may include a sensor 104 (e.g., an electronic scale) configured to measure the weight of objects placed onto or into the equipment 103, and transmit the measured weight of the objects to the computing device 106. The automated process definition generator application 114 may associate this weight measurement with a material involved in the process. As another example, a piece of equipment 103 may include a sensor 104 such as a motion sensor, or a proximity sensor, that may capture data when the equipment 103 is used to perform a step of the process (e.g., as the equipment 103 moves to perform a process step, and/or as materials are placed into the equipment 103). The automated process definition generator application 114 may use this motion or proximity data associated with the equipment 103 to determine, for instance, particular steps that involve the equipment 103 and their timing with respect to other steps of the process, and/or the duration of various steps that involve the equipment 103 during the process.

Additionally, a piece of equipment 103 may include a sensor 104 such as a location sensor that may capture data when the equipment 103 is moved within the industrial environment. In some examples, a material or a container of a material may also include a respective location sensor 104. Furthermore, in some examples, the individual may have a location sensor 104 attached to his or her person (e.g., on his or her clothing, on a lanyard, etc.). The automated process definition generator application 114 may use this locations associated with the equipment 103, materials, and/or individual to determine, for instance, particular steps that involve the equipment 103 and their timing with respect to other steps of the process, and/or the duration of various steps that involve the equipment 103 during the process. That is, the automated process definition generator application 114 may determine that process steps involving the individual, materials, and/or equipment are in progress at a particular time or duration of time based on the individual, materials, and/or equipment 103 being co-located with one another at that particular time and/or duration of time.

In some examples, the automated process definition generator application 114 may determine the set of process materials for making the product, the equipment 103 used to make the product, the set of process operations applied to the materials to make the product, a sequence of the process operations, a timing of the process operations, quantity information regarding the materials used in the process, etc., based upon applying a trained machine learning model, such as the machine learning model 116, to the data captured by the sensors 104 as the individual performs the set of process operations to the set of process materials to make the product, as discussed in greater detail below.

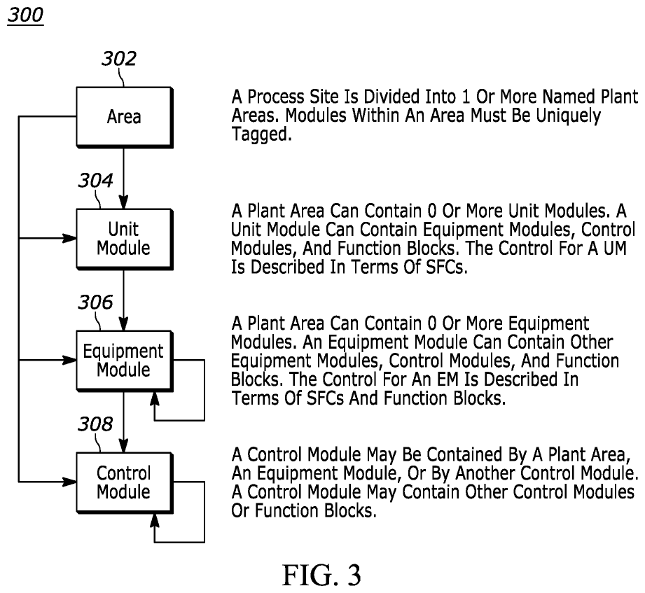

In some examples, the automated process definition generator application 114 may further determine a hierarchical level associated with one or more steps of the process, e.g., as shown in the hierarchy of FIG. 3. That is, in an example, the hierarchy of the industrial environment 102 may include an area level 302, a unit module level 304, an equipment module level 306, and a control module level 308. Particular pieces of equipment 103 may be associated with particular levels of the hierarchy of the industrial environment 102. For instance, based on determining that particular pieces of equipment 103 are involved in particular steps of the process, the automated process definition generator application 114 may determine a hierarchical level associated each step of the process, or with the process as a whole.

Executing the process visualization application 115 may include generating a visualization of the process (e.g., as identified by the automated process definition generator application 114). For instance, in some examples, the process visualization application 115 may generate an interactive user interface display that lists the steps of the process, i.e., textually or in the form of a chart or diagram such as a flow chart. Moreover, in some examples, the process visualization application 115 may generate a visualization of the individual performing the steps of the process. For instance, the process visualization application 115 may generate an augmented reality (AR) visualization of the individual performing the steps of the process, which may be overlaid over an image or video of the industrial environment 102, or may be overlaid over the actual industrial environment 102 (e.g., using a projector). The visualization of the individual performing the steps of the process may be sent to the user interface device 108, where it may be provided to the user. In some examples, the user may interact with the visualization of the individual performing the steps of the process via the user interface device 108, as discussed in greater detail below, e.g., to isolate particular steps of the process, to modify or correct particular steps of the process, etc.

In some examples, the machine learning model 116 may be executed on the computing device 106, while in other examples the machine learning model 116 may be executed on another computing system, separate from the computing device 106. For instance, the computing device 106 may send the data captured by the sensors 104 as the individual performs the set of process operations to the set of process materials to make the product to another computing system, where the trained machine learning model 116 is applied to the data captured by the sensors 104 as the individual performs the process, and the other computing system may send a prediction or identification of set of process materials for making the product, the equipment 103 used to make the product, the set of process operations applied to the materials to make the product, a sequence of the process operations, a timing of the process operations, quantity information regarding the materials used in the process, etc., based upon applying the trained machine learning model 116 to the data captured by the sensors 104 as the individual performs the process, to the computing device 106. Moreover, in some examples, the machine learning model 116 may be trained by a machine learning model training application 117 executing on the computing device 106, while in other examples, the machine learning model 116 may be trained by a machine learning model training application executing on another computing system, separate from the computing device 106.

Whether the machine learning model 116 is trained on the computing device 106 or elsewhere, the machine learning model 116 may be trained by the machine learning model training application 117 using training data corresponding to historical sensor data captured while individuals performed historical processes, and a set of process materials for making the product, the equipment 103 used to make the product, the set of process operations applied to the materials to make the product, a sequence of the process operations, a timing of the process operations, quantity information regarding the materials used in the process, etc., from each of the respective historical processes, e.g., as may be obtained from the database 119. The trained machine learning model 116 may then be applied to new sensor data (e.g., captured by the sensors 104) captured as an individual performs a new process in order to determine, e.g., a set of process materials for making the product, the equipment 103 used to make the product, the set of process operations applied to the materials to make the product, a sequence of the process operations, a timing of the process operations, quantity information regarding the materials used in the process, etc., for the new process.

In various aspects, the machine learning model 116 may comprise a machine learning program or algorithm that may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the machine learning model 116 may comprise a library or package executed on the computing device 106 (or other computing devices not shown in FIG. 1). For example, such libraries may include the TENSORFLOW based library, the PYTORCH library, and/or the SCIKIT-LEARN Python library.

Machine learning may involve identifying and recognizing patterns in existing data (such as training a model based upon historical sensor data captured while individuals performed historical processes, and a set of process materials for making the product, the equipment 103 used to make the product, the set of process operations applied to the materials to make the product, a sequence of the process operations, a timing of the process operations, quantity information regarding the materials used in the process, etc., from each of the respective historical processes) in order to facilitate making predictions or identification for subsequent data (such as using the machine learning model 116 on new sensor data associated with an individual's performance of a new process order to determine a prediction of a likely set of process materials for making the product, likely equipment 103 used to make the product, a likely set of process operations applied to the materials to make the product, a likely sequence of the process operations, a likely timing of the process operations, likely quantity information regarding the materials used in the process, etc.).

Machine learning model(s) may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

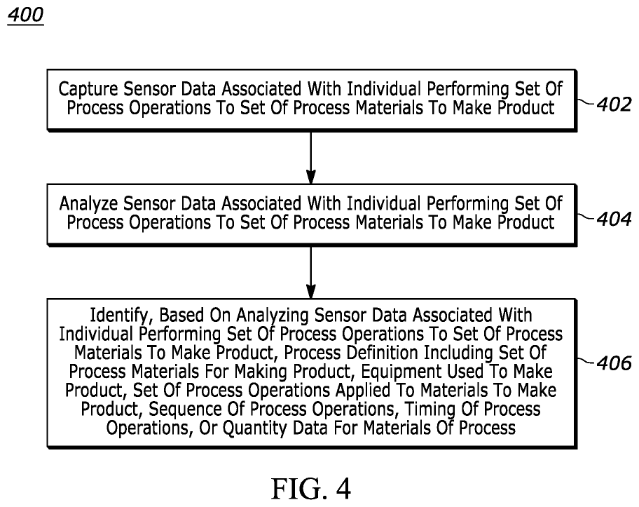

In addition, memories 112 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memory 112 may include instructions for carrying out any of the steps of any of the methods 400, 500, or 600 (which are described in greater detail below with respect to FIGS. 4, 5, and 6, respectively) via an algorithm executing on the processors 110. It should be appreciated that one or more other applications may be envisioned and that are executed by the processor(s) 110. It should be appreciated that given the state of advancements of mobile computing devices, all of the processes functions and steps described herein may be present together on a mobile computing device, such as the user interface device 108.

Generally speaking, the user interface device 108 may include, or may be configured to communicate with, a user interface display 120, which may receive input from users and may provide audible or visible output to users. In some examples, the user interface display 120 may be configured to provide an augmented reality (AR) output to users, e.g., overlaid over the industrial environment 102 and/or the equipment 103, or overlaid over an image or video of the industrial environment 102 and/or the equipment 103.

Additionally, the user interface device 108 may include one or more processor(s) 122, as well as one or more computer memories 124. Memories 124 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 124 may store an operating system (OS) (e.g., iOS, Microsoft Windows, Linux, UNIX, etc.) capable of facilitating the functionalities, apps, methods, or other software as discussed herein.

Memorie(s) 124 may also store instructions that, when executed by the one or more processor(s) 122, cause the one or more processor(s) 122 to receive graphics, AR renderings, and/or other visualizations generated by the computing device 106 associated with an individual's performance of a process, and may display the graphics, AR renderings, and/or other visualizations to a user of the user interface device 108. Furthermore, the instructions, when executed by the one or more processor(s) 122, may cause the one or more processor(s) 122 to receive input from a user of the user interface device 108 and may modify the graphics, AR renderings, and/or other visualizations based on the input from the user of the user interface device 108. For instance, the user input may include a request to isolate a graphic, AR rendering, and/or other visualization associated with a particular step or portion of the individual's performance of the process. As another example, the user input may include a request to speed up or slow down a graphic, AR rendering, and/or other visualization associated with a particular step or portion of the individual's performance of the process. Moreover, as another example, the user input may include a request to modify a graphic, AR rendering, and/or other visualization associated with a particular step or portion of the individual's performance of the process.

FIG. 4 depicts a flow diagram of an exemplary computer-implemented method 400 for automatically generating a process definition for an industrial process to create a product in an industrial plant, according to one embodiment. One or more steps of the method 400 may be implemented as a set of instructions stored on a computer-readable memory (e.g., memory 112 and/or memory 124) and executable on one or more processors (e.g., processor 110 and/or processor 122).

The method 400 may include capturing (block 402) sensor data associated with an individual performing a set of process operations to a set of process materials to make a product. For instance, in some examples, the sensor data may include image data, video data, and/or audio data, associated with an individual, captured as the individual performs one or more process operations of the set of process operations. Additionally, in some examples, the sensor data may include data from sensors associated with one or more equipment involved in the set of process operations. Furthermore, in some examples, the sensor data may include location sensor data associated with the process materials involved in the process, the equipment involved in the process, the individual involved in the process, etc.

Additionally, the method 400 may include analyzing (block 404) the sensor data associated with the individual performing the set of process operations to the set of process materials to make the product. In some examples, analyzing the sensor data may include analyzing the audio data to identify words or phrases spoken by the individual as the individual performs one or more process operations of the set of process operations.

Furthermore, the method 400 may include identifying (block 406) based on analyzing the sensor data associated with the individual performing the set of process operations to the set of process materials to make the product, a process definition including one or more of: the set of process materials for making the product, one or more equipment used to make the product, the set of process operations applied to the materials to make the product, a sequence of the process operations, a timing of the process operations, or quantity information regarding the materials used in the process.

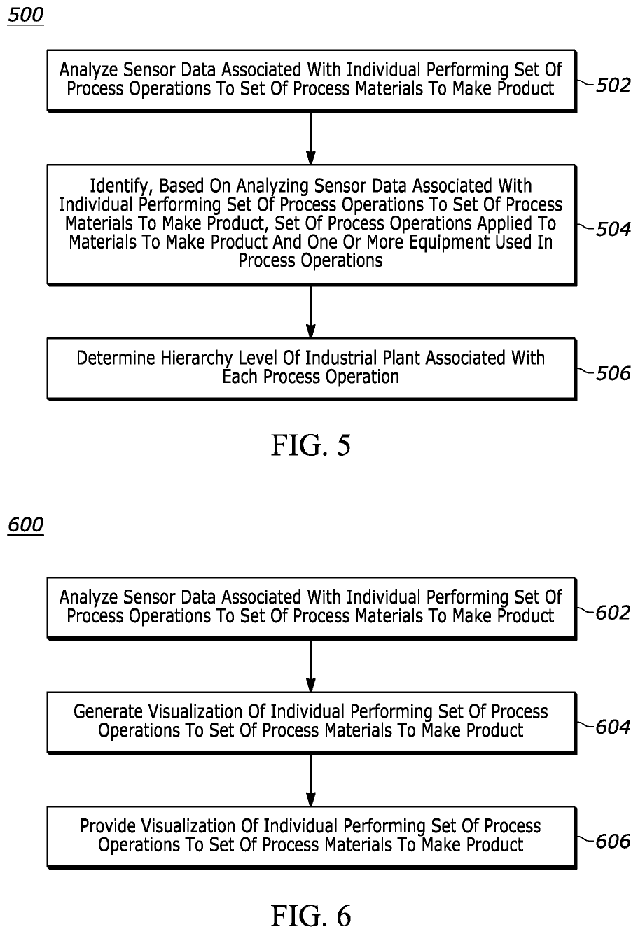

FIG. 5 depicts a flow diagram of an exemplary computer-implemented method 500 for automatically generating a configuration hierarchy for a process definition for an industrial process to create a product in an industrial plant, according to one embodiment. One or more steps of the method 500 may be implemented as a set of instructions stored on a computer-readable memory (e.g., memory 112 and/or memory 124) and executable on one or more processors (e.g., processor 110 and/or processor 122).

The method 500 may include analyzing (block 502) sensor data associated with an individual performing a set of process operations to a set of process materials to make a product.

Additionally, the method 500 may include identifying (block 504) based on analyzing the sensor data associated with the individual performing the set of process operations to the set of process materials to make the product, the set of process operations applied to the materials to make the product and one or more equipment used in each of the process operations.

Furthermore, the method 500 may include determining (block 506), based on the set of process operations applied to the materials to make the product and the one or more equipment used in each of the process operations, a hierarchy level of the industrial plant associated with each of the process operations. For instance, FIG. 3 illustrates an example plant hierarchy in an industrial plant.

FIG. 6 depicts a flow diagram of an exemplary computer-implemented method 600 for visualizing a process definition for an industrial process to create a product in an industrial plant, according to one embodiment. One or more steps of the method 600 may be implemented as a set of instructions stored on a computer-readable memory (e.g., memory 112 and/or memory 124) and executable on one or more processors (e.g., processor 110 and/or processor 122).

The method 600 may include analyzing (block 602) sensor data associated with an individual performing a set of process operations to a set of process materials to make a product.

Furthermore, the method 600 may include generating (block 604), based on captured sensor data associated with an individual performing a set of process operations to a set of process materials to make a product, a visualization of the set of process operations being performed to the set of process materials to make the product, wherein the visualization illustrates one or more of the set of process materials for making the product, one or more equipment used to make the product, the set of process operations applied to the materials to make the product, a sequence of the process operations, a timing of the process operations, or quantity information regarding the materials used in the process.

Moreover, the method 600 may include providing, via a user interface, the visualization of the individual performing the set of process operations to the set of process materials to make the product. For instance, in some examples, providing the visualization of the individual performing the set of process operations to the set of process materials to make the product includes providing an augmented reality (AR) visualization of the individual performing the set of process operations to the set of process materials to make the product. In some examples, the AR visualization of the individual performing the set of process operations to the set of process materials to make the product may be overlaid upon a process environment in which the sensor data associated with the individual performing the set of process operations to the set of process materials to make the product was captured.

In some examples, the method 600 may further include receiving input from a user requesting a particular process operation of the set of process operations and subsequently, providing, via the user interface, the visualization of the particular process operation of the set of process operations, isolated from the set of process operations, based on the input from the user.

Moreover, in some examples, the method 600 may further include receiving input from a user indicating a request to increase or decrease a speed associated with the visualization of one or more process operations of the set of process operations, and subsequently providing, via the user interface, a slowed-down or sped-up visualization of the one or more process operations of the set of process operations based on the input from the user.

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for automatically generating a process definition for an industrial process to create a product in an industrial plant. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A method of automatically generating a process definition for an industrial process to create a product in an industrial plant, the method comprising:
capturing sensor data associated with an individual performing a set of process operations to a set of process materials to make a product;
analyzing the sensor data associated with the individual performing the set of process operations to the set of process materials to make the product; and
identifying, based on analyzing the sensor data associated with the individual performing the set of process operations to the set of process materials to make the product, a process definition including one or more of: the set of process materials for making the product, one or more equipment used to make the product, the set of process operations applied to the materials to make the product, a sequence of the process operations, a timing of the process operations, or quantity information regarding the materials used in the process.

2. The method of claim 1, wherein the sensor data includes one or more of: image data, video data, or audio data, associated with an individual, captured as the individual performs one or more process operations of the set of process operations.

3. The method of claim 1, wherein the sensor data includes data from sensors associated with one or more equipment involved in the set of process operations.

4. The method of claim 1, wherein the sensor data includes location sensor data associated with one or more process materials of the set of process materials, one or more equipment involved in the set of process operations, or the individual involved in the set of process operations.

5. The method of claim 1, wherein analyzing the sensor data includes analyzing audio data to identify words or phrases spoken by the individual as the individual performs one or more process operations of the set of process operations.

6. The method of claim 1, further comprising:
providing, via a user interface, the identified process definition;
receiving, via the user interface, an adjustment of one or more of: the set of process materials for making the product, the one or more equipment used to make the product, the set of process operations applied to the materials to make the product, the sequence of the process operations, the timing of the process operations, or the quantity information regarding the materials used in the process; and
updating the process definition based on the adjustment received via the user interface.

6. A system for automatically generating a process definition for an industrial process to create a product in an industrial plant, the system comprising:
one or more sensors configured to capture sensor data associated with an individual performing a set of process operations to a set of process materials to make a product;
one or more processors;
a memory storing computer-readable instructions that, when executed by the one or more processors, cause the one or more processors to:
analyze the sensor data associated with the individual performing the set of process operations to the set of process materials to make the product; and
identify, based on analyzing the sensor data associated with the individual performing the set of process operations to the set of process materials to make the product, a process definition including one or more of: the set of process materials for making the product, one or more equipment used to make the product, the set of process operations applied to the materials to make the product, a sequence of the process operations, a timing of the process operations, or quantity information regarding the materials used in the process.

7. The system of claim 6, wherein the sensor data includes one or more of: image data, video data, or audio data, associated with an individual, captured as the individual performs one or more process operations of the set of process operations.

8. The system of claim 6, wherein the sensor data includes data from sensors associated with one or more equipment involved in the set of process operations.

9. The system of claim 6, wherein the sensor data includes location sensor data associated with one or more process materials of the set of process materials, one or more equipment involved in the set of process operations, or the individual involved in the set of process operations.

10. The system of claim 6, wherein analyzing the sensor data includes analyzing audio data to identify words or phrases spoken by the individual as the individual performs one or more process operations of the set of process operations.

11. The system of claim 6, further comprising a user interface, and wherein the computer-readable instructions, when executed by the one or more processors, further cause the one or more processors to:
provide the identified process definition via the user interface;
receive, via the user interface, an adjustment of one or more of: the set of process materials for making the product, the one or more equipment used to make the product, the set of process operations applied to the materials to make the product, the sequence of the process operations, the timing of the process operations, or the quantity information regarding the materials used in the process; and
update the process definition based on the adjustment received via the user interface.

12. A method of automatically generating a configuration hierarchy for a process definition for an industrial process to create a product in an industrial plant, the method comprising:
analyzing sensor data associated with an individual performing a set of process operations to a set of process materials to make a product;
identifying, based on analyzing the sensor data associated with the individual performing the set of process operations to the set of process materials to make the product, the set of process operations applied to the materials to make the product and one or more equipment used in each of the process operations; and
determining, based on the set of process operations applied to the materials to make the product and the one or more equipment used in each of the process operations, a hierarchy level of the industrial plant associated with each of the process operations.

13. A system for automatically generating a configuration hierarchy for a process definition for an industrial process to create a product in an industrial plant, the system comprising:
one or more processors;
a memory storing computer-readable instructions that, when executed by the one or more processors, cause the one or more processors to:
analyze sensor data associated with an individual performing a set of process operations to a set of process materials to make a product;
identify, based on analyzing the sensor data associated with the individual performing the set of process operations to the set of process materials to make the product, the set of process operations applied to the materials to make the product and one or more equipment used in each of the process operations; and
determine, based on the set of process operations applied to the materials to make the product and the one or more equipment used in each of the process operations, a hierarchy level of the industrial plant associated with each of the process operations.

14. A method of visualizing a process definition for an industrial process to create a product in an industrial plant, the method comprising:
analyzing sensor data associated with an individual performing a set of process operations to a set of process materials to make a product;
generating, based on analyzing the sensor data associated with the individual performing the set of process operations to the set of process materials to make the product, a visualization of the set of process operations being performed to the set of process materials to make the product, wherein the visualization illustrates one or more of the set of process materials for making the product, one or more equipment used to make the product, the set of process operations applied to the materials to make the product, a sequence of the process operations, a timing of the process operations, or quantity information regarding the materials used in the process; and
providing, via a user interface, the visualization of the individual performing the set of process operations to the set of process materials to make the product.

15. The method of claim 14, wherein providing the visualization of the individual performing the set of process operations to the set of process materials to make the product includes providing an augmented reality (AR) visualization of the individual performing the set of process operations to the set of process materials to make the product.

16. The method of claim 15, wherein providing the AR visualization of the individual performing the set of process operations to the set of process materials to make the product includes providing the AR visualization of the individual performing the set of process operations to the set of process materials to make the product, overlaid upon a process environment in which the sensor data associated with the individual performing the set of process operations to the set of process materials to make the product was captured.

17. The method of claim 14, further comprising:
receiving input from a user requesting a particular process operation of the set of process operations; and
providing, via the user interface, the visualization of the particular process operation of the set of process operations, isolated from the set of process operations, based on the input from the user.

18. The method of claim 14, further comprising:
receiving input from a user indicating a request to increase or decrease a speed associated with the visualization of one or more process operations of the set of process operations; and
providing, via the user interface, a slowed-down or sped-up visualization of the one or more process operations of the set of process operations based on the input from the user.

19. A system for visualizing a process definition for an industrial process to create a product in an industrial plant, the system comprising:
a user interface;
one or more processors;
a memory storing computer-readable instructions that, when executed by the one or more processors, cause the one or more processors to:
analyze sensor data associated with an individual performing a set of process operations to a set of process materials to make a product;
generate, based on analyzing the sensor data associated with the individual performing the set of process operations to the set of process materials to make the product, a visualization of the set of process operations being performed to the set of process materials to make the product, wherein the visualization illustrates one or more of the set of process materials for making the product, one or more equipment used to make the product, the set of process operations applied to the materials to make the product, a sequence of the process operations, a timing of the process operations, or quantity information regarding the materials used in the process; and
provide, via the user interface, the visualization of the individual performing the set of process operations to the set of process materials to make the product.

20. The system of claim 19, wherein providing the visualization of the individual performing the set of process operations to the set of process materials to make the product includes providing an augmented reality (AR) visualization of the individual performing the set of process operations to the set of process materials to make the product.

21. The system of claim 20, wherein providing the AR visualization of the individual performing the set of process operations to the set of process materials to make the product includes providing the AR visualization of the individual performing the set of process operations to the set of process materials to make the product, overlaid upon a process environment in which the sensor data associated with the individual performing the set of process operations to the set of process materials to make the product was captured.

22. The system of claim 19, wherein the instructions, when executed by the one or more processors, further cause the one or more processors to:
receive input from a user requesting a particular process operation of the set of process operations; and
provide, via the user interface, the visualization of the particular process operation of the set of process operations, isolated from the set of process operations, based on the input from the user.

23. The system of claim 19, wherein the instructions, when executed by the one or more processors, further cause the one or more processors to:
receive input from a user indicating a request to increase or decrease a speed associated with the visualization of one or more process operations of the set of process operations; and
provide, via the user interface, a slowed-down or sped-up visualization of the one or more process operations of the set of process operations based on the input from the user.
